(19) United States
(12) Patent Application Publication
(10) Pub. No.: US 2008/0260986 A1
(43) Pub. Date: Oct. 23, 2008

(54) SYSTEM AND METHOD FOR FORMING A NON-LINEAR CHANNEL WITHIN A MOLDED COMPONENT

(76) Inventor: RONALD M. SMITH, Frankfort, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/960,123

(22) Filed: Dec. 19, 2007

Related U.S. Application Data
(60) Provisional application No. 60/925,347, filed on Apr. 19, 2007.

(51) Int. Cl. B29C 33/12

(52) U.S. Cl. 428/67; 425/468; 264/277

(57) ABSTRACT

Embodiments of the present invention provide a system and method for forming a non-linear channel through a molded component. The system includes a forming device having a molding chamber, and a malleable core-out pin positioned within the molding chamber. The malleable core-out pin includes at least one curve. Liquid plastic is injected into the molding chamber and flows around the malleable core-out pin to form the molded component. After the plastic solidifies and cools, the malleable core-out pin is removed from the molded component to form the non-linear channel through the molded component.

### RELATED APPLICATIONS

This application relates to and claims priority benefits from U.S. Provisional Patent Application No. 60/925,347 entitled “Core-Out Apparatus and Method,” filed Apr. 19, 2007, which is hereby incorporated by reference in its entirety.

### FIELD OF THE INVENTION

Embodiments of the present invention generally relate to a system and method for forming a channel within a molded plastic part, and more particularly to a system and method that are configured to form a non-linear channel within a molded plastic component.

### BACKGROUND OF THE INVENTION

In order to form a hole or channel within a molded part, a rigid straight core pin is typically used. The pin itself is usually formed of hard steel. During a forming process, after plastic flows around the rigid core pin, the plastic cools and solidifies. When the core pin is pulled out of the part, a linear channel defined by the rigid straight core pin is formed through the solidified plastic.

In various applications, however, a non-linear channel may be desired. The rigid straight core pin is unable to form such a channel, particularly in a plastic part. Thus, in order to form a channel through such a plastic part, multiple rigid straight core pins may typically be used. For example, two core pins perpendicularly oriented with respect to one another may be inserted into a mold. Such a process increases manufacturing costs and time. Additionally, the abrupt, straight edged angle formed by multiple rigid pins may snag items threaded through the channel.

### SUMMARY OF THE INVENTION

Embodiments of the present invention provide a system and method that efficiently form curved channels through molded components.

Certain embodiments of the present invention provide a system for forming a non-linear channel through a molded component. The system includes a forming device having a molding chamber, and a malleable core-out pin positioned within the molding chamber. The malleable core-out pin includes at least one curve or smooth sweeping bend. Plastic is injected into the molding chamber and flows around the malleable core-out pin to form the molded component. After the plastic solidifies and cools to form the molded component, the malleable core-out pin is removed to form the non-linear channel through the molded component.

The malleable core-out pin may be formed of soft steel, aluminum, gold or the like, depending on the desired malleability. The core-out pin may be formed of a rolled metal that is stretched to form a wire.

The malleable core-out pin re-shapes as it is removed from the molded component. That is, the core-out pin curves in conformity with the non-linear channel as it is extracted from the channel.

The molded component may include a base connected to a termination pocket and a port tube. The termination pocket may be offset from the port tube.

Certain embodiments of the present invention provide a molded component that includes a base, a termination pocket integrally formed with the base, a port tube extending from the base, and at least one curved core-out pin extending from the termination pocket to the port tube. The curved core-out pin is malleable and includes first and second ends. The first end extends out of the port tube and the second end extends into the termination pocket. The curved core-out pin is removed from the molded component to form a curved channel extending from the port tube to the termination pocket.

The at least one core-out pin may include two core-out pins configured to form channels for leads of a thermistor. The curved core-out pin(s) re-shape based on the shape of the curved channel(s) as they are removed from the molded component.

Certain embodiments of the present invention provide a method of forming a non-linear channel within a molded component. The method may include forming a malleable core-out pin, curving the malleable core-out pin to conform to a shape of a curved channel to be formed within the molded component, positioning the curved, malleable core-out pin within a molding chamber of a forming device, disposing or dispensing liquid plastic into the molding chamber around the curved, malleable core-out pin, allowing the liquid plastic to solidify and cool to form the molded component, removing the molded component from the molding chamber after the allowing step, and extracting the curved, malleable core-out pin from the molded component after the removing step to form the non-linear channel within the molded component.

The extracting step includes re-shaping the curved, malleable core-out pin during movement through the formed non-linear channel. That is, the core-out pin re-shapes itself as it is extracted. The method may also include threading an electrical lead into the non-linear channel after the extracting step.

The forming step may include rolling a malleable metal into a thin wire. Further, the curving step may include forming a rounded 900 bend in the core-out pin.

### BRIEF DESCRIPTION OF SEVERAL VIEWS OF THE DRAWINGS

FIG. 1 illustrates an isometric view of a core-out pin in a first configuration according to an embodiment of the present invention.

FIG. 2 illustrates an isometric view of a core-out pin in a second configuration according to an embodiment of the present invention.

FIG. 3 illustrates an isometric view of core-out pins positioned within a plastic injection molding chamber of a forming device according to an embodiment of the present invention.

FIG. 4 illustrates an isometric top view of a molded component after being removed from a plastic injection molding chamber according to an embodiment of the present invention.

FIG. 5 illustrates an isometric top view of a molded component after core-out pins have been removed and a thermistor is partially installed in formed channels according to an embodiment of the present invention.

FIG. 6 illustrates an isometric top view of a molded component supporting a fully-installed thermistor according to an embodiment of the present invention.

FIG. 7 illustrates a flow chart of a method of forming a non-linear channel within a molded plastic part according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

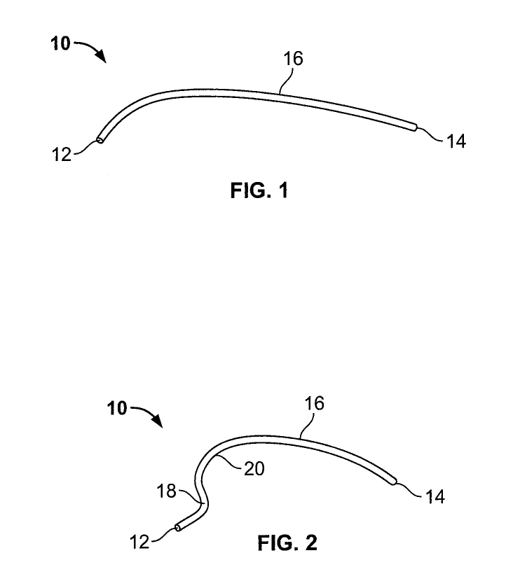

FIG. 1 illustrates an isometric view of a core-out pin 10 in a first configuration according to an embodiment of the present invention. The core-out pin 10 is a malleable piece of metal. For example, the core-out pin may be a rolled piece of soft steel, gold or aluminum wire. The core-out pin 10 includes a first end 12 connected to a second end 14 through a rolled and stretched wire 16. The core-out pin 10 does not necessarily need to be a piece of rolled and stretched wire. Instead, the core-out pin 10 may be formed through any process that ensures malleability. That is, the core-out pin 10 is formed to be a malleable cylinder having a particular gauge, diameter, circumference and the like, depending on the size of a channel to be formed. For instance, if a channel of relatively large diameter is desired, the core-out pin 10 is formed accordingly. Because the core-out pin 10 is malleable, it may be bent and shaped into various curved configurations.

FIG. 2 illustrates an isometric view of the core-out pin 10 in a second configuration according to an embodiment of the present invention. As shown in FIG. 2, the malleable nature of the core-out pin 10 allows it to be bent and shaped to have multiple arcuate bends and curves 18 and 20.

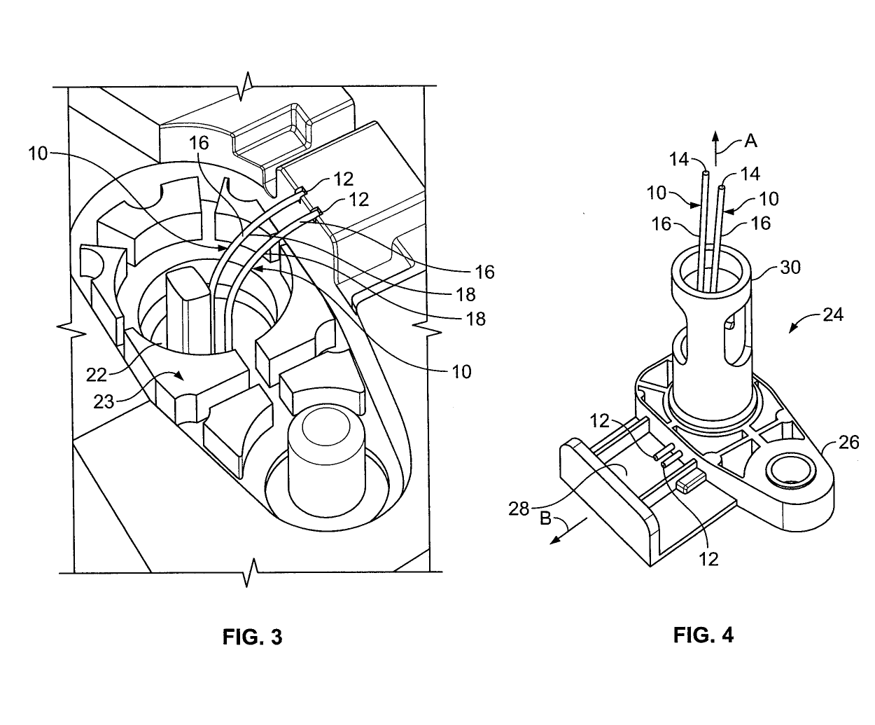

FIG. 3 illustrates an isometric view of core-out pins 10 positioned within a plastic injection molding chamber 22 of a forming device 23 according to an embodiment of the present invention. The forming device 23 may be formed of steel and includes the molding chamber 22 defined therein.

The core-out pins 10 are positioned within the molding chamber 22 such that the ends 12 protrude out of the molding chamber 22. As shown in FIG. 3, the arcuate bends 18 are within the molding chamber 22. In this instance, the core-out pins 10 are shaped such that the arcuate bends 18 form a rounded bend, such as a gently curved perpendicular bend. That is, the end 12 is perpendicularly oriented with respect to the bend 14 (hidden within the molding chamber 22). The wire 16 does not include any abrupt, straight-edge angles, however. Instead, the wire 16 is smoothly curved.

While the core-out pins 10 are shaped similar to that shown in FIG. 1, the core-out pins 10 may be shaped and formed in a variety of orientations, depending on the shape of a desired channel to be formed through a plastic component. For example, the core-out pins 10 may be bent to include a plurality of arcuate bends 18 over the length of the wire 16.

Hot liquid plastic is poured or injected into the molding chamber 22 after the core-out pins 10 are positioned therein. Once the plastic solidifies and cools, the resulting plastic molded component may be removed from the molding chamber 22.

FIG. 4 illustrates an isometric top view of a molded component 24 after being removed from the plastic injection molding chamber 22 (shown in FIG. 3) according to an embodiment of the present invention. The molded component 24 includes a base 26 connected to a termination pocket 28. A port tube 30 extends upwardly from the base 26. As shown, the port tube 30 is not linearly aligned with the pocket 28. Instead, the port tube 30 and the pocket 28 are offset with respect to one another. In this particular application, channels are to be formed through the port tube 30 that lead into the pocket 28. As such, channels having arcuate turns are to be formed.

As shown in FIG. 4, the core-out pins 10 are positioned within the molded component 24 after the molded component 24 is removed from the molding chamber 22. The ends 14 of the core-out pins 10 extend upwardly out of the port tube 30, while the ends 12 protrude into the pocket 28. In order to form a channel, the ends 14 of the core-out pins 10 are grasped and pulled out of the molded component in the direction of arrow A. As the core-out pins 10 are removed, they bend and curve in conformity with the formed channels. That is, as the wires 16 and ends 12 of the core-out pins 10 encounter curved portions of the formed channel, the wires 16 and ends 12 bend and curve as they move through those portions of the channels due to the malleability of the core-out pins 10. This is in stark contrast to rigid pins that are incapable of bending. Instead, rigid pins would scrape, snag, or otherwise compromise the integrity of curved channels as they were moved therethrough.

Once the core-out pins 10 are removed from the molded component 24, smooth, curved channels are formed through the molded component 24. That is, the solidified plastic ensures that smooth, curved channels remain within the molded component 24 after the core-out pins 10 are removed.

While the molded component 24 is shown having a base 26, pocket 28 and port tube 28, the molded component 24 may be various shapes and sizes depending upon a particular application. Additionally, the core-out pins 10 may be shaped and bent in various configurations before being inserted into the molding chamber 22 (shown in FIG. 3) depending on the shapes of desired channels to be formed through the molded component 24.

Additionally, while the core-out pins 10 are grasped by the ends 14 and pulled in the direction of arrow A, the core-out pins 10 may be removed through another area. For example, the core-out pins 10 may be grasped by the ends 12 and pulled out of the molded component 24 in the direction of arrow B.

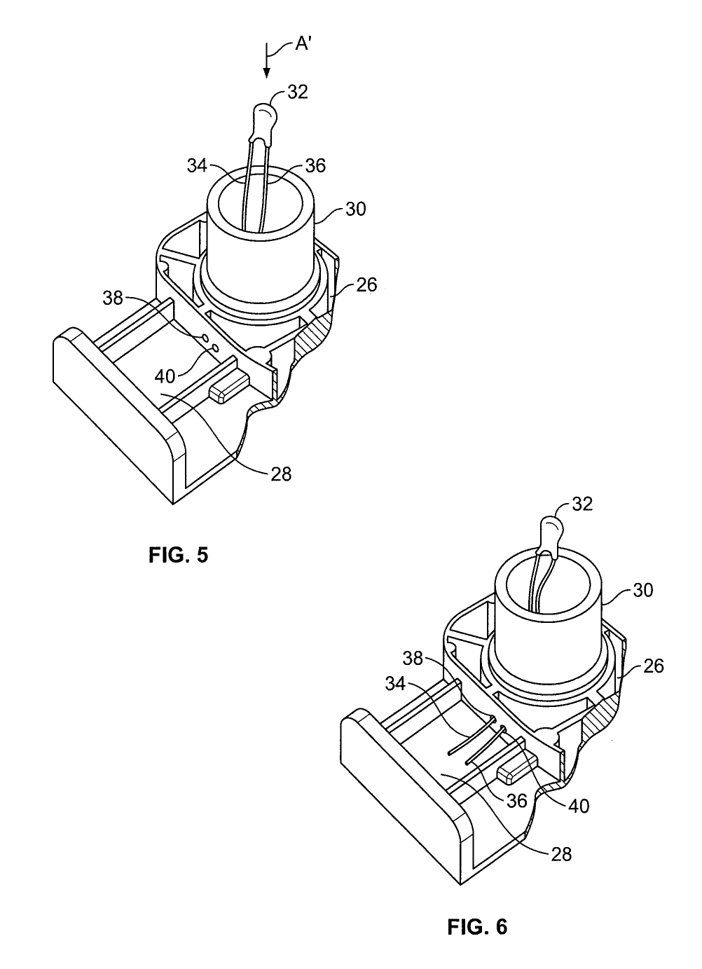

FIG. 5 illustrates an isometric top view of the molded component 24 after the core-out pins 10 (shown in FIGS. 1-4) have been removed and a thermistor 32 is partially installed in formed channels according to an embodiment of the present invention. The thermistor 32 may include two leads 34 and 36. An end of each lead 34, 36 is positioned within a hole leading into a channel formed by the removal of the core-out pins 10. Once the leads 34 and 36 are positioned within the channels, the thermistor 32 is urged in the direction of arrow A′. As the thermistor 32 is moved into the channels, the leads 34 and 36 thread into the formed channels and curve and bend in conformity with the formed channels. The thermistor 32 continues to be urged into the molded component 24 until the leads 34 and 36 extend out through holes 38 and 40 that lead into the pocket 28.

FIG. 6 illustrates an isometric top view of the molded component 24 supporting a fully-installed thermistor 32 according to an embodiment of the present invention. As shown in FIG. 6, the leads 34 and 36 have been moved through the formed channels such that they protrude out of the holes 38 and 40, respectively.

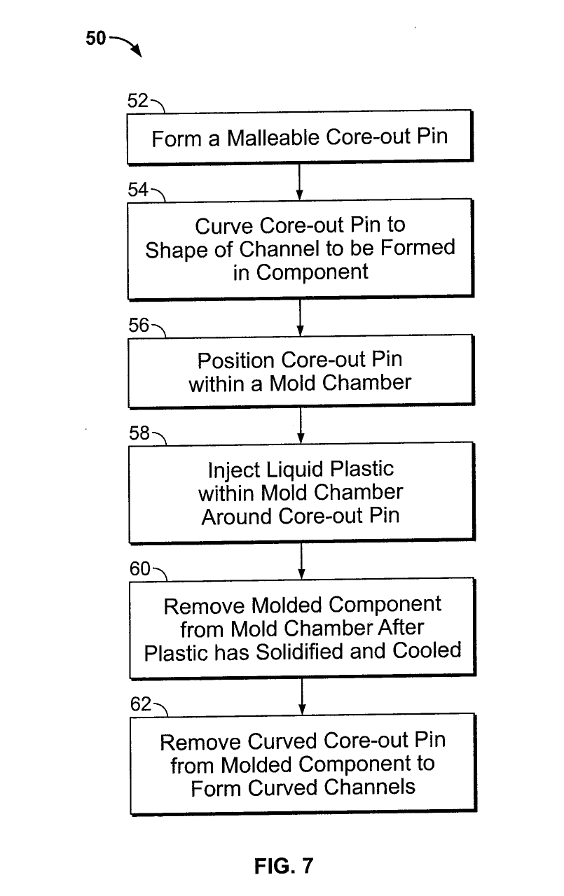

FIG. 7 illustrates a flow chart 50 of a method of forming a non-linear channel within a molded plastic part according to an embodiment of the present invention. At 52, a malleable core-out pin is formed, as discussed above with respect to FIG. 1. For example, soft steel, gold, aluminum, or another malleable metal may be rolled and stretched into a thin wire.

Next, at 54, the malleable core-out pin is bent and shaped to the shape of a channel to be formed through a molded component. As discussed above, for example, the core-out pin may be bent to have a smooth, curved bend such that one end of the core-out pin is perpendicularly-oriented with respect to the other end.

The core-out pin is then positioned within a molding chamber of a forming device at 56. The curved portion of the core-out pin is within the molding chamber. Next, plastic is injected, poured or otherwise flows into the molding chamber around the core-out pin at 58. The plastic surrounds the curved portion of the core-out pin, but not the ends of the core-out pin. Optionally, at least one end of the core-out pin may be surrounded by plastic. Such a situation may arise in which a channel having only one open end is desired, or in which portions (e.g., scraps or flashing) of the ensuing molded plastic component are later removed to expose the end(s) of the core-out pin.

Next, at 60, the molded component is removed from the molding chamber after the plastic solidifies and cools. Finally, at 62, the curved core-out pin is removed from the molded component. For instance, an end of the core-out pin may be grasped and pulled. Thus, the core-out pin is removed from the molded component and a smooth curved channel is formed within the molded component. Once the core-out pin is removed, it may be discarded and ultimately recycled.

Thus, embodiments of the present invention provide an apparatus and method for forming curved channels within molded components. The malleable core-out pins described above provide an efficient and easy way to form the channels. A single malleable core-out pin may form a curved channel. Moreover, because the core-out pin is malleable, it is safely removed from the molded component without damaging the resulting formed channel.

Embodiments of the present invention provide a core-out apparatus that is configured to form holes within a molded part that are connected together by a non-linear path. For example, embodiments of the present invention allow a termination pocket to be located somewhere other than directly in line with a port tube. The core-out apparatus shown and described allows the termination pocket to be located away from the port tube of a molded housing. By locating the termination pocket away from a computer chip or substrate pocket, lead wires may be attached without concern for damaging delicate wire bond surfaces of the chip or substrate pocket.

While various spatial terms, such as upper, lower, mid, lateral, horizontal, vertical, and the like may used to describe portions of the embodiments discussed above, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A system for forming a non-linear channel through a molded component comprising:
a forming device having a molding chamber; and
a malleable core-out pin positioned within said molding chamber, said malleable core-out pin comprising at least one curve, wherein plastic is injected into said molding chamber and flows around said malleable core-out pin to form the molded component, and wherein said malleable core-out pin is removed from the molded component after the plastic solidifies to form the non-linear channel through the molded component.

2. The system of claim 1, wherein said malleable core-out pin is formed of soft steel.

3. The system of claim 1, wherein said malleable core-out pin is formed of rolled aluminum.

4. The system of claim 1, wherein said malleable core-out pin is formed of gold wire.

5. The system of claim 1, wherein said malleable core-out pin re-shapes as it is removed from the molded component.

6. The system of claim 1, wherein the molded component comprises a base connected to a termination pocket and a port tube, wherein the termination pocket is offset from the port tube.

7. A molded component comprising:
a base;
a termination pocket integrally formed with said base;
a port tube extending from said base; and
at least one curved core-out pin extending from said termination pocket to said port tube, said at least one curved core-out pin being malleable and comprising first and second ends, wherein said first end extends out of said port tube and said second end extends into said termination pocket, wherein said at least one curved core-out pin is removed from the molded component to form a curved channel extending from said port tube to said termination pocket.

8. The molded component of claim 7, wherein said at least one core-out pin comprises two core-out pins configured to form channels for leads of a thermistor.

9. The molded component of claim 7, wherein said at least one core-out pin is formed of soft steel.

10. The molded component of claim 7, wherein said at least one core-out pin is formed of aluminum.

11. The molded component of claim 7, wherein said at least one core-out pin is formed of gold.

12. The molded component of claim 7, wherein said at least one curved core-out pin re-shapes based on the shape of said curved channel as it is removed from the molded component.

13. The molded component of claim 7, wherein said port tube is offset from said termination pocket.

14. A method of forming a non-linear channel within a molded component comprising:
forming a malleable core-out pin;
curving the malleable core-out pin to conform to a shape of a curved channel to be formed within the molded component;
positioning the curved, malleable core-out pin within a molding chamber of a forming device;
disposing liquid plastic into the molding chamber around the curved, malleable core-out pin;
allowing the liquid plastic to solidify and cool to form the molded component;
removing the molded component from the molding chamber after said allowing; and
extracting the curved, malleable core-out pin from the molded component after said removing to form the non-linear channel within the molded component.

15. The method of claim 14, wherein said extracting comprises re-shaping the curved, malleable core-out pin during movement through the non-linear channel.

16. The method of claim 14, further comprising threading an electrical lead into the non-linear channel after said extracting.

17. The method of claim 14, wherein said forming comprises rolling a malleable metal into a thin wire.

18. The method of claim 14, wherein said curving comprises forming a rounded 90° bend in the core-out pin.
